(19) United States
(12) Patent Application Publication
(10) Pub. No.: US 2010/0098249 A1
(43) Pub. Date: Apr. 22, 2010

(54) METHOD AND APPARATUS FOR ENCRYPTING DATA AND METHOD AND APPARATUS FOR DECRYPTING DATA

(75) Inventors: Jun-bum SHIN, Suwon-si (KR); So-young LEE, Hwaseong-si (KR); Jin-mok KIM, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/472,462

(22) Filed: May 27, 2009

(30) Foreign Application Priority Data
Oct. 16, 2008 (KR) 10-2008-0101612

(51) Int. Cl. H04L 9/06

(52) U.S. Cl. 380/44; 380/29

(57) ABSTRACT

Provided are a method and apparatus for encrypting data, and a method and apparatus for decrypting data. The method of encrypting data includes generating an encryption key by using current time information indicating a current time, encrypting data by using the generated encryption key, and transmitting the encrypted data.

### CROSS-REFERENCE TO RELATED PATENT APPLICATION

This application claims priority from Korean Patent Application No. 10-2008-0101612, filed on Oct. 16, 2008 in the Korean Intellectual Property Office, the disclosure of which is incorporated herein in its entirety by reference.

### BACKGROUND OF THE INVENTION

1. Field of the Invention

Methods and apparatuses consistent with the present invention relate to encrypting data and decrypting data.

2. Description of the Related Art

Recently, with the development of information communication technology, information is frequently transmitted. An information provider needs to transmit information in such a way that the information is not intercepted by other people, and encryption may be performed on the information to achieve this.

Encryption means replacing plaintext with a certain code so that only an intended user can interpret the meaning. Data Encryption Standard (DES) and Rivest Shamir Adleman (RSA), which are encryption ciphers using an exchange key or common/private key system, are examples of such encryption.

### SUMMARY OF THE INVENTION

The present invention provides a method and apparatus for effectively encrypting and decrypting data.

According to an aspect of the present invention, there is provided a method of encrypting data, the method including: generating an encryption key by using current time information indicating a current time; encrypting data by using the encryption key; and transmitting the encrypted data.

The generating of the encryption key may include: calculating a counter value indicating a time interval between a reference time and the current time indicated by the current time information; and obtaining a function value corresponding to the counter value by using a predetermined hash function.

The method may further include: receiving a request signal for requesting transmission of the current time information from a client; and transmitting the current time information to the client in response to the request signal.

The method may further include generating encryption key type information indicating a type of the encryption key, based on the counter value, wherein the transmitting of the encrypted data further comprises transmitting the encryption key type information.

The encryption key may include a control word used to realize a conditional access (CA) system, and the transmitting of the encrypted data further transmits an entitlement management message including information about a reception qualification of a client.

According to another aspect of the present invention, there is provided a method of decrypting data, the method including: receiving current time information indicating a current time in a server that transmits encrypted data, from the server; generating a decryption key that is to be used to decrypt the encrypted data, based on the current time information; and decrypting the encrypted data by using the decryption key.

The generating of the decryption key may include: calculating a counter value indicating a time interval between a reference time and the current time indicated by the current time information; and obtaining a function value corresponding to the counter value by using a predetermined hash function.

The receiving of the current time information may further receive the encrypted data and encryption key type information indicating a type of an encryption key used to encrypt the data, and the generating of the decryption key may include: determining whether the counter value corresponds to the encryption key type information; and compensating the counter value based on a result of the determining.

The decryption key may include a control word used to realize a CA system, and the receiving of the current time information may further include receiving an entitlement management message including information about a reception qualification of a client.

The information about the reception qualification may include information about a point of time when the reception qualification of the client changes, and the method may further include requesting to re-transmission of the entitlement management message based on the information about the point of time when the reception qualification of the client changes.

According to another aspect of the present invention, there is provided an apparatus for encrypting data, the apparatus including: an encryption key generating unit which generates an encryption key by using current time information indicating a current time; an encrypting unit which encrypts data by using the generated encryption key; and a transmitting unit which transmits the encrypted data.

According to another aspect of the present invention, there is provided an apparatus for decrypting data, the apparatus including: a receiving unit which receives current time information indicating a current time in a server that transmits encrypted data, from the server; a decryption key generating unit which generates a decryption key that is to be used to decrypt the encrypted data, based on the current time information; and a decrypting unit which decrypts the encrypted data by using the generated decryption key.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating an apparatus for encrypting data, according to an exemplary embodiment of the present invention;

FIG. 2 is a diagram for describing a process of encrypting data by using the apparatus of FIG. 1, according to an exemplary embodiment of the present invention;

FIG. 3 is a diagram illustrating a packet structure into which encryption key type information is inserted, according to an exemplary embodiment of the present invention;

FIG. 4 is a block diagram illustrating an apparatus for decrypting data, according to an exemplary embodiment of the present invention;

FIG. 5 is a diagram for describing a process of compensating a counter value by using the apparatus of FIG. 5;

FIG. 6 is a flowchart illustrating a method of encrypting data, according to an exemplary embodiment of the present invention;

FIG. 7 is a flowchart illustrating a method of decrypting data, according to an exemplary embodiment of the present invention; and

FIG. 8 is a diagram illustrating data flow between systems including an apparatus for encrypting data and an apparatus for decrypting data, according to an exemplary embodiment of the present invention.

### DETAILED DESCRIPTION OF EXEMPLARY EMBODIMENTS

Hereinafter, the present invention will be described more fully with reference to the accompanying drawings, in which exemplary embodiments of the invention are shown.

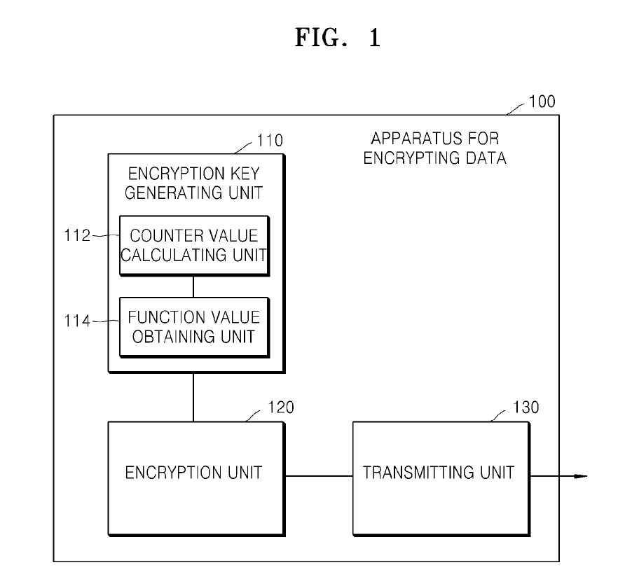

FIG. 1 is a block diagram illustrating an apparatus 100 for encrypting data, according to an exemplary embodiment of the present invention. The apparatus 100 includes an encryption key generating unit 110, an encryption unit 120, and transmitting unit 130.

The encryption key generating unit 110 generates an encryption key by using current time information. The current time information is information indicating a current time in the apparatus 100. The current time information is not limited to any particular form, and may be indicated in hours, minutes, and seconds, or a value converted into units of seconds.

The encryption key generating unit 110 may include a counter value calculating unit 112 and a function value obtaining unit 114.

The counter value calculating unit 112 calculates a counter value indicating a time interval between a reference time and a current time. The reference time is a basis for calculating the counter value. For convenience of description, the reference time is 00:00 am. Accordingly, when a current time is 13:00:00, a time interval is 13×60×60 seconds, i.e., 46800 seconds.

A unit of the counter value may vary according to exemplary embodiments of the present invention, for example, 1 second or 10 seconds. In the above example, when the unit of the counter value is 1 second, the counter value is 46800 (seconds), and when the unit of the counter value is 10 seconds, the counter value is 4680 (10 seconds). In the latter case, the counter value is identical for 10 seconds, and since the encryption key is generated based on the counter value, the encryption key is identical for 10 seconds. As such, a changing cycle of the encryption key is determined according to the unit of the counter value, and thus the unit of the counter value is determined according to exemplary embodiments of the present invention.

The function value obtaining unit 114 obtains a function value corresponding to the counter value, by using a predetermined function. In other words, the function value is obtained by inputting the counter value to the predetermined function.

A function used by the function value obtaining unit 114 is not limited to any particular type. For example, the function value obtaining unit 114 may use a hash function which generates the same output values with respect to the same input values and generates different output values with respect to the different output values. Alternatively, the function value obtaining unit 114 may use a key derivation function (KDF).

However, a client that wishes to decrypt encrypted data may generate a decryption key by using the same function that is used by the apparatus 100. Accordingly, the apparatus 100 uses a hash function (or KDF) that is pre-determined by the client or provides information about the hash function (or KDF) that is used by the apparatus 100 to the client.

The function value obtaining unit 114 may use the obtained function value as an encryption key or generate an encryption key by re-processing the function value.

The encryption key generating unit 110 may further include an encryption key type information generating unit (not shown).

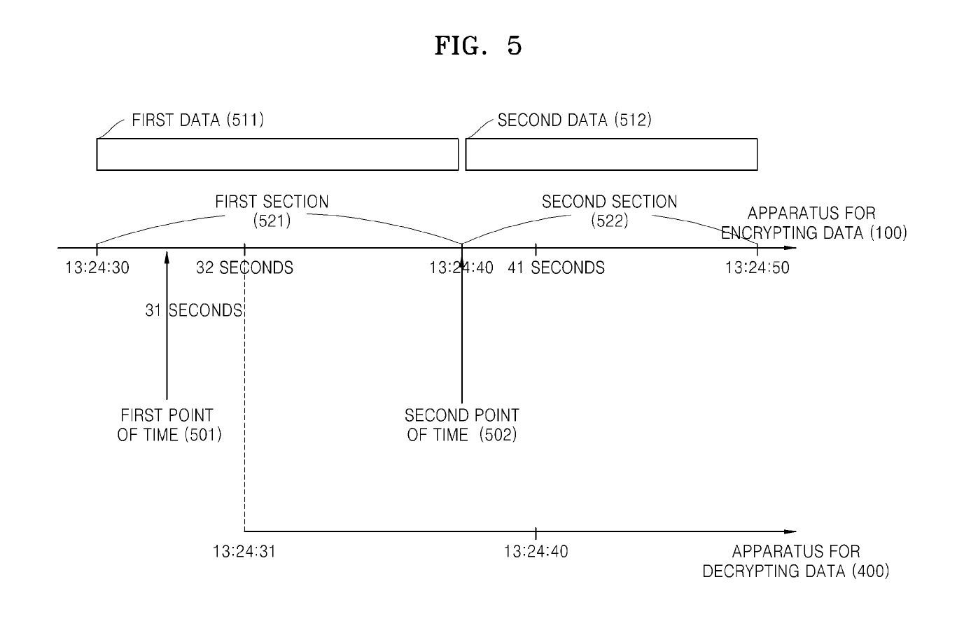

The encryption key type information generating unit generates encryption key type information indicating a type of the encryption key. A basis for classifying the type of the encryption key may vary according to exemplary embodiments. For example, the encryption key may be classified into an even key and an odd key based on whether the counter value is an even or odd number. The encryption key type information helps the client to generate an accurate decryption key. Accordingly, when the type of the encryption key is variously classified, the client may generate an accurate decryption key but complexity increases. An exemplary embodiment of using the encryption key type information will be described in detail later with reference to FIG. 5.

The encryption unit 120 encrypts data by using the generated encryption key. The transmitting unit 130 transmits the encrypted data.

According to an exemplary embodiment of the present invention, the function value obtaining unit 114 or the encryption unit 120 may further use an additional parameter in order to provide a higher level of security. When the encryption key is generated by using only the counter value, anyone who obtained the current time information can readily analogize the encryption key.

For example, the function value obtaining unit 114 may obtain the function value by using the counter value and the additional parameter as input values of a predetermined function so as to generate the encryption key, or the encryption key 120 may encrypt the data by using the encryption key and the additional parameter. In other words, the additional parameter may be used to generate the encryption key along with the counter value, or to encrypt the data along with the encryption key. The additional parameter is not limited to any particular form, and a random number is possible.

When the data is encrypted by using the encryption key and additional parameters, the transmitting unit 130 transmits the additional parameters.

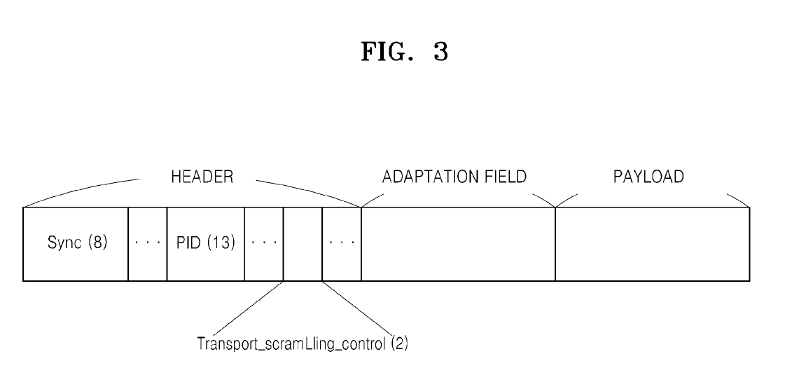

The transmitting unit 130 may further transmit the encryption key type information. Specifically when the data is transmitted in a transport stream (TS) packet form, the encryption key type information may be transmitted after being recorded in a predetermined field of a header of the TS packet. An example of the TS packet in which the encryption key type information is recorded will be described in detail later with reference to FIG. 3.

The apparatus 100 may further include a signal receiving unit (not shown) and an information transmitting unit (not shown).

The signal receiving unit receives a request signal requesting transmission of the current time information from the client.

The information transmitting unit transmits the current time information in response to the request signal. Here, the information transmitting unit determines whether the client requesting the current time information is authorized, and transmits the current time information only when the client is authorized.

The apparatus 100 may provide a broadcasting service via a conditional access (CA) system. The CA system is a system for adjusting viewing authority according to a subscriber, and encrypts a part of or the entire data so that only an authorized subscriber can reproduce the data.

According to a conventional CA system, data is scrambled by using a control word. The control word is encrypted by a service key, and transmitted in an entitlement control message (ECM). The service key is encrypted by a private key, and is transmitted in the entitlement management message (EMM). Since an authorized client includes a private key, the service key is obtained by processing the EMM. Then, the data is decrypted by obtaining the control word by using the service key and the ECM. The authorized client is allowed to receive the service, and includes a corresponding private key.

When a CA system is implemented by using the apparatus 100, the control word is included in the encryption key generated based on the current time information. The apparatus 100 does not transmit the encryption key by encrypting the encryption key by using another key like a service key, but instead transmits the current time information to the authorized client. Accordingly, the client is able to generate a decryption key corresponding to the encryption key. Consequently in the apparatus 100, the ECM may not be transmitted.

However, according to an exemplary embodiment of the present invention, the EMM may be separately transmitted. The EMM may include information about a viewing qualification of the client. The information about the viewing qualification of the client may indicate a point of time when the viewing qualification is changed, for example, a point of time when authorization is terminated, and a user analyzes the EMM so as to request the apparatus 100 to re-transmit the EMM at the point of time when the viewing qualification is changed. Here, the point of time when the viewing qualification is changed may be indicated in the counter value.

The EMM may include additional information required for decryption. As described above, the counter value and the additional parameter are used to generate the encryption key or the encryption key and the additional parameter are used to encrypt the data. Here, the used additional parameter may be included in the EMM.

In the conventional CA system, a channel is wasted since the ECM or EMM is transmitted with the data. Also, when the ECM or EMM is transmitted with the encrypted data, a separate multiplexing process is required, and thus complexity and expenses increase. However according to the current exemplary embodiment, the encryption key is generated by using the current time information, and thus a channel is not wasted, and a separate multiplexing process is not required. Accordingly, a structure of a system is simpler and less expensive.

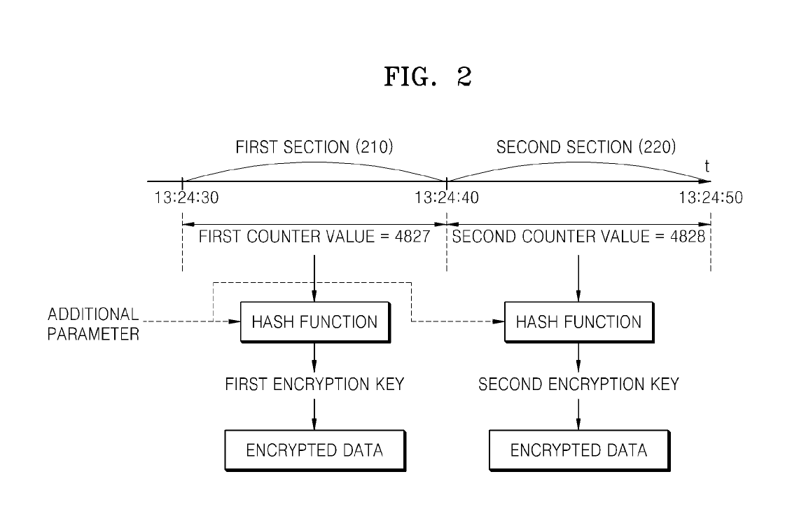

FIG. 2 is a diagram for describing a process of encrypting data by using the apparatus 100 of FIG. 1, according to an exemplary embodiment of the present invention.

Referring to FIG. 2, a unit of the counter value in the apparatus 100 is 10 seconds, and the counter value and the encryption key changes every 10 seconds.

A first section 210 is a section wherein a current time of the apparatus 100 is between 13:24:30 and 13:24:40. In FIG. 2, the reference time is 0:0:0. Accordingly, a counter value of the first section 210 is a value of a time interval from 0:0:0 to 13:24:40 shown in unit of 10 seconds. According to Equation 1 below, a first counter value, i.e., the counter value of the first section 210 is 4827.

Count Value=((hours×3600)+(minutes×60)+seconds)/10 (1)

The function value obtaining unit 114 obtains the function value by using the first counter value as an input value of the hash function. For convenience of description, it is assumed that a function used by the function value obtaining unit 114 is a hash function. However, the function value obtaining unit 114 may use other functions, such as key derivation function (KDF). The function value obtaining unit 114 may obtain the function value by only using the first counter value, or by using the first counter value and the additional parameter in order to increase security. In this case, a client that is to decrypt the data must share the additional parameter, and thus the apparatus 100 may transmit the additional parameter via a separate channel. The obtained function value may be used as a first encryption key, or may be processed to generate the first encryption key.

The apparatus 100 encrypts the data by using the first encryption key, and transmits the encrypted data to the client.

A second section 220 is a section wherein a current time of the apparatus 100 is between 13:24:40 and 13:24:50.

When the current time is 13:24:41, a second counter value is ((13×3600)+(24×60)+41)/10=4828 according to Equation 1 above. Accordingly, the second counter value in the second section 220 is 4828.

The function value obtaining unit 114 encrypts the data by using a second encryption key and the additional parameter, and transmits the encrypted data.

As described above, the apparatus 100 generates the encryption key by using the current time information, and encrypts the data by using the generated encryption key. The client synchronizes time by obtaining the current time information from the apparatus 100. Then, the data is decrypted by generating a decryption key corresponding to the encryption key by using the synchronized current time information. However, when the client requests the apparatus 100 for the current time information but obtaining of the current time information is delayed, the current time information obtained by the client and the current time information actually used by the apparatus 100 may not be identical. In other words, time may not be accurately synchronized between the apparatus 100 and the client, and in this case, the client is unable to generate an accurate decryption key.

In the case where the client is unable to generate the accurate decryption key, the apparatus 100 may further transmit encryption key type information to the client as information required to compensate the counter value or the decryption key. The client may determine an error in the decryption key or the counter value and compensate the error by using the encryption key type information. Details thereof will be described in detail later with reference to FIG. 5.

The encryption key may be classified based on whether the counter value used to generate the encryption key is an even number or an odd number. In FIG. 2, the first counter value of 4827 is an odd number, and thus the first encryption key generated by using the first counter value is an odd key. Meanwhile, the second counter value of 4828 is an even number, and thus the second encryption key generated by using the second counter value is an even key.

While transmitting the encrypted data, the transmitting unit 130 transmits the encryption key type information with the encrypted data. The encryption key type information may be inserted into a header of a packet of the encrypted data. An example of a packet structure into which the encryption key type information is inserted will now be described with reference to FIG. 3.

FIG. 3 is a diagram illustrating a packet structure into which encryption key type information is inserted, according to an exemplary embodiment of the present invention.

A packet according to an exemplary embodiment of the present invention may be an MPEG-2 TS packet, and may include a header, an adaptation field, and a payload.

The adaptation field includes additional information about payload data or padding data. The adaptation field may not exist according to another exemplary embodiment of the present invention, and existence of the adaption field may be indicated by an adaptation field flag in the header.

The payload includes main data. Encrypted data is included in the payload of the packet according to an exemplary embodiment of the present invention.

The header includes a synchronization (sync) field used to identify the beginning of the packet, a packet identifier (PID) field used to identify the packet, and a “transport_srambling_control” field containing the encryption key type information.

The “transport_srambling_control” field may be formed of two bits, and may include information about whether an encryption key is an odd key or an even key. Here, the first bit indicates whether data transmitted via the payload is encrypted, and the second bit indicates which type of encryption key is used to encrypt the data.

For example, when a field value is 00, payload data is not encrypted, and when the field value is 10, the payload data is encrypted by an even key. Also, when the field value is 11, the payload data is encrypted by using an odd key, and when the field value is 01, a separate function may not be added to the payload data so as to be used later. Table 1 below shows functions according to a field value of the “transport_srambling_control” field.

TABLE 1

| transport_srambling_control | |
|---|---|
| flag | Function |
| 00 | Payload data not encrypted |
| 01 | Reserved |
| 10 | Payload data encrypted by using even key |
| 11 | Payload data encrypted by using odd key |

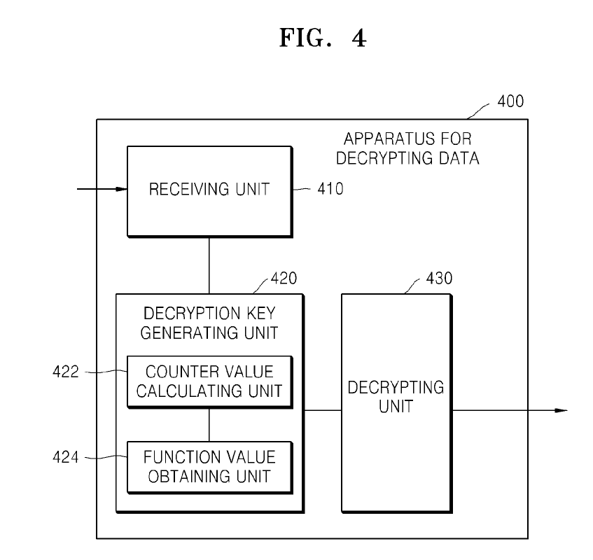

FIG. 4 is a block diagram illustrating an apparatus 400 for decrypting data, according to an exemplary embodiment of the present invention.

The apparatus 400 according to the current exemplary embodiment of the present invention includes a receiving unit 410, a decryption key generating unit 420, and a decrypting unit 430.

The receiving unit 410 synchronizes time by receiving current time information indicating a current time of a server that transmits encrypted data, from the server. The receiving unit 410 may receive the current time information via a path that is different from a path for receiving the encrypted data.

The decryption key generating unit 420 generates a decryption key to be used to decrypt the encrypted data based on the current time information. The decryption key generating unit 420 may include a counter value calculating unit 422 and a function value obtaining unit 424.

The counter value calculating unit 422 calculates a counter value indicating a time interval between a reference time and a current time indicated by the current time information. A time interval unit may vary according to a changing cycle of the encryption key. The time interval between the reference time and the current time may be indicated in units of seconds, for example, units of 10 seconds.

The apparatus 400 may further include a determining unit (not shown) and a compensating unit (not shown) in order to determine an error in the calculated counter value.

The determining unit determines whether an error exists in the counter value. For example, when the receiving unit 410 receives encryption key type information indicating a type of an encryption key used in encryption from the server, the determining unit determines whether the counter value corresponds to the encryption key type information. Assuming that the encryption key is classified into an even key and an odd key based on whether the counter value is an even number and an odd number, when the counter value is an odd number despite the encryption key type information being an even key, an error exists in the counter value.

The compensating unit compensates for the error in the counter value. A process of compensating for an error in the counter value will be described in detail later with reference to FIG. 5.

The function value obtaining unit 424 inputs the counter value (or the compensated counter value) to a predetermined hash function so as to obtain a function value corresponding to the counter value. The function value obtaining unit 424 may use the same hash function used to generate the encryption key. Accordingly, a hash function may be predetermined by communicating with the server, or information about the hash function may be received from the server.

While generating the encryption key, the server may use the counter value and an additional parameter in order to increase security. In this case, the function value obtaining unit 424 also uses the additional parameter, and thus receives information about the additional parameter. When the server provides broadcasting service by realizing a CA system, the additional parameter may be transmitted to the receiving unit 410 after being included in an EMM.

The decrypting unit 430 decrypts the encrypted data by using the decryption key.

The decryption key may include a control word for implementing the CA system. The CA system is a system for limiting a viewing qualification according to a subscriber. In the CA system, services viewable by a subscriber and a nonsubscriber, a charged subscriber and a free subscriber, and a high-grade subscriber and a un-high-grade subscriber, among charged subscribers, are different. As such, in order to limit a viewing qualification according to a subscriber, the server transmits information about the viewing qualification. The information about the viewing qualification is transmitted via the EMM, and content of the information about the viewing qualification changes in uniform periods.

The information about the viewing qualification may include information about the point of time when the viewing qualification of the client changes, and the point of time may be indicated as a counter value. Accordingly, the apparatus 400 may request the server to re-transmit the EMM before or after a predetermined time from the point of time when the information about the viewing qualification is received, based on the counter value.

FIG. 5 is a diagram for describing a process of compensating a counter value by using the apparatus 400 of FIG. 5.

In FIG. 5, the apparatus 100 changes the counter value and the encryption key in units of 10 seconds. For convenience of description, it is assumed that the encrypted data is transmitted from the apparatus 100 in real-time without delay, and the current time information is received with a 1 second delay. Such a delay may occur when a channel for transmitting the encrypted data and a channel for transmitting the current time information are different, or when the same channels are used to transmit the encrypted data and the current time information but the current time information is transmitted at a point of time when transmission requests are numerous.

The apparatus 100 generates the counter value based on the current time information, and encrypts the data by generating the encryption key from the counter value. A first section is a section between 13:24:30 and 13:24:40. Based on Equation 1, a counter value in the first section 521 is 4827. Accordingly, the apparatus 100 encrypts first data 511 by generating an encryption key by inputting 4827 to a predetermined hash function.

In FIG. 5, a type of the encryption key is classified according to whether the counter value used to generate the encryption key is an odd number or an even number. In other words, the encryption key is classified as an odd key when the encryption key is generated by using an odd counter value, and is classified as an even key when the encryption key is generated by using an even counter value. Accordingly, the encryption key used to encrypt the first data 511 is an odd key.

The encryption key type information may be transmitted with the first data 511, and when the first data 511 has a packet form, the encryption key type information is recorded in a certain field in a header of the packet.

Assuming that the apparatus 400 requested the current time information at a first point of time 501. The current time at the first point of time 501 is 13:24:31. Since it takes one second for the apparatus 400 to receive the current time information after requesting the current time information, an error between the current time of the apparatus 400 and that of the apparatus 100 is one second.

An upper time axis in FIG. 5 is the current time in the apparatus 100, and a lower time axis in FIG. 5 is the current time set in the apparatus 400 based on the current time information. A second point of time 502 is 13:24:40 in the apparatus 100 but 13:24:39 in the apparatus 400.

Accordingly, after the second point of time 502, the counter value in the apparatus 100 is changed to 4828. The apparatus 100 generates the encryption key by inputting the counter value 4828 to the predetermined hash function, and encrypts second data 512 by using the encryption key.

However, the counter value in the apparatus 400 is still 4827. The apparatus 400 generates the decryption key by inputting the counter value 4827 to the predetermined hash function. As a result, since the apparatus 100 generates the encryption key by using the counter value 4828 and the apparatus 400 generates the decryption key by using the counter value 4827, the apparatus 400 is unable to decrypt the second data 512.

As such, in order to reduce an error of the counter values due to inaccurate synchronization of a current time, the apparatus 100 transmits the encryption key type information. The encryption key type information may be recorded in a certain field of a header of the second data 512, and the apparatus 400 extracts the encryption key type information from the header. Since the second data 512 is encrypted by using the encryption key generated from the counter value 4828, the encryption key type information includes information that the encryption key is an even key.

The counter value calculated at the second point of time 502 is 4827 and is thus an odd number, but the type of the encryption key is the even key. Accordingly, the apparatus 400 determines an error in the calculated counter value. When the error exists in the calculated counter value, the apparatus 400 compensates for the error by adding 1 to the calculated counter value. Accordingly, the apparatus 400 compensates the counter value to 4828, and generates the decryption key by using the compensated counter value.

According to the current exemplary embodiment, the encryption key is classified into two types for convenience of description, but by subdividing the type of the encryption key, for example, the remainder left by dividing by 3 and the remainder left by dividing by 4, the counter value may be accurately compensated.

As described above, by transmitting the encryption key type information with the encrypted data, the encrypted data is effectively decrypted even when time is not accurately synchronized.

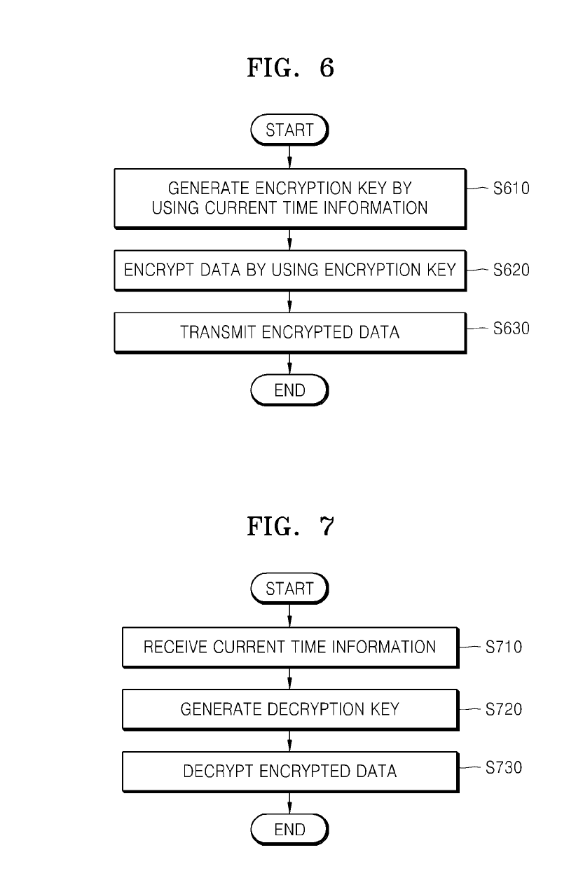

FIG. 6 is a flowchart illustrating a method of encrypting data, according to an exemplary embodiment of the present invention.

In operation S610, an encryption key is generated by using current time information. The encryption key is obtained by calculating a counter value indicating a time interval between a reference time and the current time, and then inputting the calculated counter value to a hash function. Here, encryption key type information indicating a type of the encryption key may be further generated.

In operation S620, data is encrypted by using the encryption key.

The encryption key may be generated by using the counter value and an additional parameter in operation S610, or the data may be encrypted by using the encryption key and the additional parameter in operation S620. Here, a client may be aware of which additional parameter is used.

In operation S630, the encrypted data is transmitted. The encrypted data may be transmitted in a TS packet form, and the encryption key type information may be included in a header of the packet. The encryption key may be a control word for implementing a CA system. Here, an EMM containing information about a reception qualification of the client may be transmitted with the encrypted data. When the additional parameter is used in operation S610 or S620, the information about the additional parameter may be transmitted in the EMM. In addition, the EMM may include various types of additional information, such as information about a point of time when the reception qualification of the client changes.

FIG. 7 is a flowchart illustrating a method of decrypting data, according to an exemplary embodiment of the present invention.

In operation S710, current time information indicating a current time of a server that transmits encrypted data is received from the server. Here, encryption key type information indicating a type of encryption key used to encrypt data may also be received.

In operation S720, a decryption key that is to be used to decrypt the encrypted data is generated based on the current time information. The decryption key may be obtained by calculating a counter value indicating a time interval between a reference time and the current time and then inputting the counter value in a hash function. Here, the encryption key type information is referred to in order to determine whether an error exists in the counter value. When the counter value corresponds to the encryption key type information, the decryption key is generated by using the counter value. However, when the counter value does not correspond to the encryption key type information, the counter value is compensated and then the decryption key is generated.

In operation S730, the encrypted data is decrypted by using the decryption key.

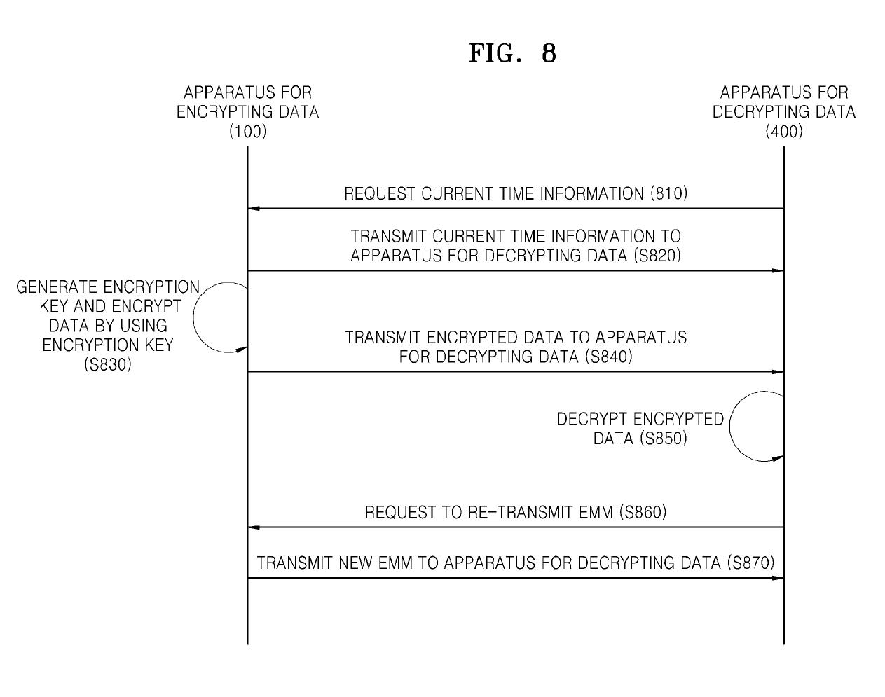

FIG. 8 is a diagram illustrating data flow between systems including the apparatus 100 and the apparatus 400, according to an exemplary embodiment of the present invention.

The apparatus 400 requests the apparatus 100 for current time information indicating a current time in operation S810.

The apparatus 100 transmits the current time information to the apparatus 400 in operation S820. Here, the apparatus 100 may transmit the current time information to the apparatus 400 after determining whether the apparatus 400 is an authorized apparatus. Upon receiving the current time information, the apparatus 400 synchronizes time with the apparatus 100 by using the current time information.

The apparatus 100 generates an encryption key by using the current time information, and encrypts data by using the encryption key in operation S830.

The apparatus 100 transmits the encrypted data to the apparatus 400 in operation S840. Here, a path for transmitting the encrypted data and a path for transmitting the current time information may be different. The encrypted data may be in a packet form, and encryption key type information indicating a type of the encryption key may be included in a header of the packet.

The apparatus 400 provides a service to a user by decrypting the encrypted data in operation S850.

The apparatus 400 decrypts the encrypted data as follows.

First, the apparatus 400 calculates a counter value indicating a time interval between a reference time and a current time based on the current time information.

Next, the apparatus 400 determines whether the calculated counter value corresponds to the encryption key type information. For example, when the encryption key is an even key even when the counter value is an odd number, the counter value and the encryption key type information do not correspond with each other. Such a case may occur when a time of the apparatus 400 and a time of the apparatus 100 are not accurately synchronized. When the calculated counter value does not correspond to the encryption key type information, the counter value is compensated so as to obtain an accurate counter value.

Once the accurate counter value is obtained, the counter value is input to a hash function in order to generate the decryption key. Then, the encrypted data is decrypted by using the generated decryption key.

The apparatus 400 requests re-transmission of an EMM in operation S860. The EMM includes information about reception qualification of the apparatus 400, and may include information about a point of time when the reception qualification changes. The point of time when the reception qualification changes may be indicated in a counter value, and the apparatus 400 requests re-transmission of the EMM by referring to the counter value calculated at a current point of time and the EMM.

In operation S870, the apparatus 100 transmits a new EMM to the apparatus 400.

The exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), and optical recording media (e.g., CD-ROMs, or DVDs).

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of encrypting data, the method comprising:
generating an encryption key based on current time information indicating a current time;
encrypting data using the encryption key; and
transmitting the encrypted data.

2. The method of claim 1, wherein the generating the encryption key comprises:
calculating a counter value indicating a time interval between a reference time and the current time indicated by the current time information; and
obtaining a function value corresponding to the counter value by using a predetermined hash function.

3. The method of claim 1, further comprising:
receiving a request to transmit the current time information; and
transmitting the current time information in response to the request.

4. The method of claim 3, further comprising generating encryption key type information indicating a type of the encryption key, based on the counter value,
wherein the transmitting the encrypted data comprises transmitting the encryption key type information and the encrypted data.

5. The method of claim 1, wherein the encryption key comprises a control word for implementing a conditional access system, and
the transmitting the encrypted data comprises transmitting the encrypted data and an entitlement management message comprising information about a reception qualification.

6. A method of decrypting data, the method comprising:
receiving current time information indicating a current time in a device that transmits encrypted data;
generating a decryption key based on the current time information; and
decrypting the encrypted data by using the decryption key.

7. The method of claim 6, wherein the generating the decryption key comprises:
calculating a counter value indicating a time interval between a reference time and the current time indicated by the current time information; and
obtaining a function value corresponding to the counter value by using a predetermined hash function.

8. The method of claim 7, wherein the receiving the current time information comprises receiving the current time information, the encrypted data and encryption key type information indicating a type of an encryption key used to encrypt the data, and
the generating the decryption key comprises:
determining whether the counter value corresponds to the encryption key type information; and
compensating the counter value based on a result of the determining.

9. The method of claim 6, wherein the decryption key comprises a control word for implementing a conditional access system, and
the receiving the current time information comprises receiving the current time information and an entitlement management message comprising information about a reception qualification.

10. The method of claim 9, wherein the information about the reception qualification comprises information about a point of time when the reception qualification changes, and
the method further comprises requesting re-transmission of the entitlement management message based on the information about the point of time when the reception qualification changes.

11. An apparatus for encrypting data, the apparatus comprising:
an encryption key generating unit which generates an encryption key based on current time information indicating a current time;
an encrypting unit which encrypts data using the generated encryption key; and
a transmitting unit which transmits the encrypted data.

12. The apparatus of claim 11, wherein the encryption key generation unit comprises:
a counter value calculating unit which calculates a counter value indicating a time interval between a reference time and the current time; and
a function value obtaining unit which obtains a function value corresponding to the counter value by using a predetermined hash function.

13. The apparatus of claim 11, wherein the encryption key generation unit further comprises:
a signal receiving unit which receives a request to transmit the current time information; and
an information transmitting unit which transmits the current time information in response to the request signal.

14. The apparatus of claim 13, further comprising an encryption key type information generating unit, which generates encryption key type information indicating a type of the encryption key, based on the counter value,
wherein the transmitter further transmits the encryption key type information.

15. The apparatus of claim 11, wherein the encryption key comprises a control word for implementing a conditional access system, and
the transmitter further transmits an entitlement management message comprising information about a reception qualification.

16. An apparatus for decrypting data, the apparatus comprising:
a receiving unit which receives current time information indicating a current time in a device that transmits encrypted data;
a decryption key generating unit which generates a decryption key based on the current time information; and
a decrypting unit which decrypts the encrypted data by using the generated decryption key.

17. The apparatus of claim 16, wherein the decryption key generator comprises:
a counter value calculator which calculates a counter value indicating a time interval between a reference time and the current time; and
a function value obtaining unit which obtains a function value corresponding to the counter value by using a predetermined hash function.

18. The apparatus of claim 17, wherein the receiving unit further receives the encrypted data and encryption key type information indicating a type of an encryption key used to encrypt the data, and
the decryption key generating unit comprises:
a determining unit which determines whether the counter value corresponds to the encryption key type information; and
a compensating unit which compensates the counter value based on a result of the determination by the determining unit.

19. The apparatus of claim 16, wherein the decryption key comprises a control word for implementing a conditional access system, and
the receiving unit further receives an entitlement management message comprising information about a reception qualification.

20. The apparatus of claim 19, wherein the information about the reception qualification comprises information about a point of time when the reception qualification changes, and
the apparatus further comprises a requesting unit which requests re-transmission of the entitlement management message based on the information about the point of time when the reception qualification changes.

21. A computer readable recording medium having recorded thereon a program for executing the method of claim 1.
